(19) United States
(12) Patent Application Publication
(10) Pub. No.: US 2024/0202688 A1
(43) Pub. Date: Jun. 20, 2024

(54) SYSTEM AND METHOD FOR PROVIDING BANKING SERVICES TO CRYPTOCURRENCY ACCOUNTS

(71) Applicant: NCR Corporation, Atlanta, GA (US)

(72) Inventor: Bryan Walser Nonni, Atlanta, GA (US)

(21) Appl. No.: 18/082,059

(22) Filed: Dec. 15, 2022

(51) Int. Cl. G06Q 20/10; G06Q 20/04; G06Q 20/32; G06Q 20/38

(52) U.S. Cl. CPC G06Q 20/1085; G06Q 20/0425; G06Q 20/3221; G06Q 20/3223; G06Q 20/3267; G06Q 20/381; G06F 3/04847

(57) ABSTRACT

A system and method for interfacing between a financial institution and a cryptocurrency exchange is disclosed. A back-end application programming interface (API) receives a request for a banking transaction from a user in a first amount in fiat money related to a financial institution account a second amount in cryptocurrency funds related to a cryptocurrency exchange account. The API communicates with the financial institution to cause the banking transaction in the first amount to be performed by the financial institution on the account of the user at the financial institution. The API converts the second amount in fiat money to an amount of cryptocurrency funds. The API communicates with the cryptocurrency exchange to cause the banking transaction in the amount of cryptocurrency funds to be performed by the cryptocurrency exchange on the account of the user at the cryptocurrency exchange.

### FIELD

This disclosure relates generally to a system and method for providing banking services to cryptocurrency accounts, and more particularly to a system and method for interfacing between a financial institution such as a bank and a cryptocurrency exchange account which provides a cryptocurrency exchange account holder with access to the same types of banking services available to bank account holders.

### BACKGROUND

A cryptocurrency is a digital currency that works as a medium of exchange through a computer network not reliant on any central authority, such as a government or bank, to uphold or maintain it. Cryptocurrency is a decentralized system for verifying that parties to a transaction have the money they claim to have, eliminating the need for traditional intermediaries, such as banks, when funds are being transferred between two entities. Individual ownership records are stored in a digital ledger, a computerized database using strong cryptography to secure transaction records that is based on blockchain technology. A cryptocurrency exchange is a business that allows customers to trade cryptocurrencies for other assets, such as conventional fiat money or other digital currencies.

Cryptocurrencies continue to grow in popularity and become more commonplace with consumers. As cryptocurrencies become more widely used among consumers, banks and other financial service providers are becoming increasingly interested in making cryptocurrency services and products available to their customers. However, because of regulatory constraints, banks are currently limited in the types of cryptocurrency services they may directly provide. This makes access to cryptocurrencies via a traditional banking interface, such as an automated teller machine (ATM) difficult to offer. As a result, consumers are currently forced to use unfamiliar dedicated cryptocurrency systems and interfaces separately from how they access their traditional bank accounts, e.g., via a bank ATM.

In addition, banking may become more open and less regulated in the future. Traditional banks will need the ability to control custody of digital assets for their customers as regulators continue to reduce restrictions and banks continue to forge partnerships with companies that offer these services. A natural consequence of these partnerships and shift in banking will be a desire by consumers for all of the normal banking services available from a bank but using their new digital assets.

Accordingly, because of the drawbacks recited above, there is a need for an improved a system and method for interfacing between a financial institution such as a bank and a cryptocurrency exchange account which provides a cryptocurrency exchange account holder with access to the same types of banking services available to bank account holders via a same or similar interface.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system for interfacing between a financial institution such as a bank and a cryptocurrency exchange account according to the present disclosure;

FIG. 2 is a block diagram of a server system for hosting an application program interface according to the present disclosure;

FIG. 3 is a flowchart of a method for providing traditional banking services for cryptocurrency exchange accounts according to a first aspect of the present disclosure;

FIG. 4 is a flowchart of a method for providing traditional banking services for cryptocurrency accounts according to a second aspect of the present disclosure; and

FIG. 5 is a flowchart of a method for providing traditional banking services for cryptocurrency accounts according to a third aspect of the present disclosure.

### DETAILED DESCRIPTION

In the present disclosure, like reference numbers refer to like elements throughout the drawings, which illustrate various exemplary embodiments of the present disclosure.

The present disclosure describes a system and method for interfacing between a financial institution such as a bank and a cryptocurrency exchange account which provides a cryptocurrency account holder with access to the same types of banking services available to bank account holders via a same or similar interface. The system and method provide a solution based on bank-end processing (between the financial institution and the cryptocurrency exchange) that converts amounts of fiat money to cryptocurrency, and vice versa, in order to provide traditional banking services to a user having a cryptocurrency account. This back-end processing allows the user to do mobile check cashing directly into a cryptocurrency account, to issue physical or digital checks backed by funds in a cryptocurrency account, cash checks from and deposit checks to a cryptocurrency account at an ATM, and to cash checks from and deposit checks to a cryptocurrency account at a bank location (financial institution) via an interaction with a teller.

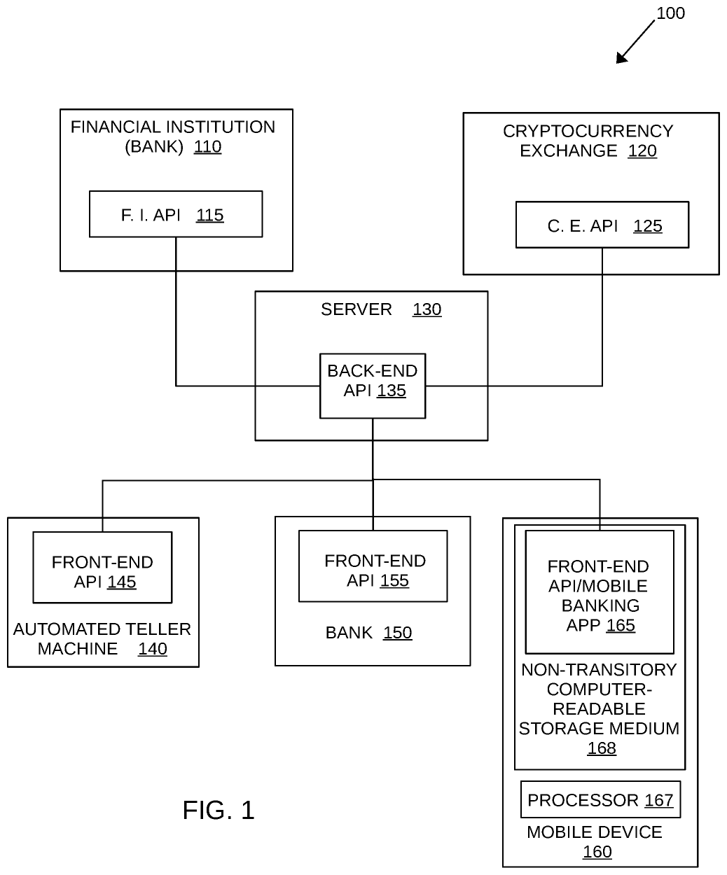

Referring now to FIG. 1, the system 100 provides a back-end application programming interface (API) 135 which runs on, for example, a server 130 that interfaces between a financial institution API 115 at a financial institution (bank) 110 and a cryptocurrency exchange API 125 at a cryptocurrency exchange (platform) 120. In one case, the integration services provided via the back-end API 135 (discussed below) may be provided by a third-party independent from the financial institution 110 and the cryptocurrency exchange 120, and in this situation, server 130 may be based remotely from the financial institution and from the cryptocurrency exchange 120, for example as a cloud-based server. In another case, the integration services may be provided by the cryptocurrency exchange 120 and in this situation the server 130 may be located at the cryptocurrency exchange 120 (and may be, but is not required to be, the same server that runs the cryptocurrency exchange API 125). In yet another case (in the event that banking regulations are changed to so allow this), the integration services may be provided by the financial institution 110 and in this situation the server 130 may be located at the financial institution 110.

The back-end API 135 is communicatively coupled to a financial institution API 115 that runs on a server at the financial institution 110 and to a cryptocurrency exchange API 125 that runs on a server at the cryptocurrency exchange 120. In addition, the back-end API 135 is communicatively coupled to a front-end API 145 provided at an automated p, to a front-end API 155 at a location of a bank 150 (for access via teller), and/or to a front-end API/mobile banking application (app) 165 operating on a mobile device 160. The one ATM 140, the location of one bank 150, and the single mobile device 160 shown in FIG. 1 are representative only and, as one of ordinary skill in the art will readily recognize, there can be a plurality of ATMs 140 and a plurality of locations of banks 150 distributed within a region, and a plurality of users each having their own mobile device 160, and all are communicatively coupled to the back-end API 135 to provide the services discussed herein. The mobile banking app 165 is provided on a non-transitory computer-readable storage medium 168 (e.g., a hard disk as discussed below) and is executed by a processor 167 to provide the features discussed below.

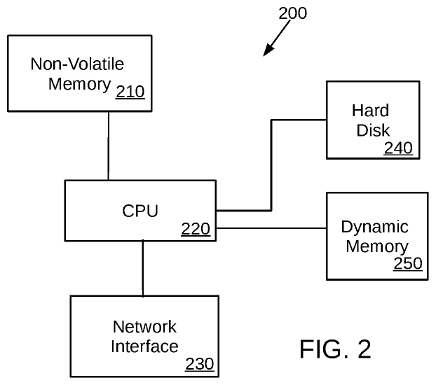

Each server discussed with respect to FIG. 1 may correspond to a server 200 as shown in FIG. 2. Each server 200 is preferably a hardware-based computing system which includes one or more central processing units 220, a network interface 230, at least one hard disk (HD) 240, volatile memory 250, and non-volatile memory 210. The non-volatile memory 210 may include a basic input/output system (BIOS) used to initiate a boot of the server 200. The HD 240 may be any type of non-volatile memory device (i.e., a non-transitory computer-readable storage medium) used to hold an operating system for a computer-based system (and application programs including APIs) and the term “hard disk” as used herein is intended to be broadly defined to include both electro-mechanical data storage devices and solid-state drives. The HD 240 holds the programs (software applications) which load into volatile memory 250 upon boot of the operating system to provide the functionality of such programs, including the one or more of the APIs discussed herein. It is to be noted that the components are shown schematically in greatly simplified form, with only those components relevant to understanding of the embodiments being illustrated. The various components (that are identified in the FIG. 2) are illustrated and the arrangement of the components is presented for purposes of illustration only. It is to be noted that other arrangements with more or less components are possible without departing from the teachings of the system and method presented herein. In one presently preferred embodiment, server 200 comprises a computing system adapted to run a secure version of the Microsoft Windows® operating system or a secure Linux distribution.

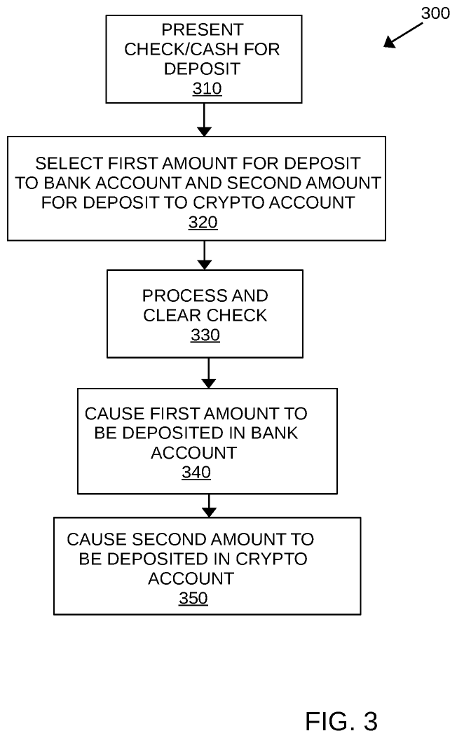

Referring now to FIG. 3, a flowchart 300 is shown that describes the process for depositing a check (or cash) according to aspects of the present disclosure. First, at step 310, a user presents a check (or cash) for deposit into their bank account and/or into their cryptocurrency (crypto) account. This may be done at an ATM 140, to a teller at a bank 150, or, if the deposit is a check, via the mobile banking app 165 provided via mobile device 160. The user is then prompted at step 320 to select a first percentage of the total amount of the deposit to be deposited into their bank account (the first amount for deposit is the first percentage times the total of the deposit) and a second percentage of the total amount of the deposit to be deposited into their crypto account (the second amount for deposit is the second percentage times the total of the deposit). This may be done via a slider interface at the ATM 140 or mobile banking app 165, the slider interface providing, for example, a pointer moving linearly from 0/100 to 100/0 so that the total of the two percentages will always be 100 percent. The teller will prompt the user to select a correct first percentage and second percentage when the transaction is performed at a bank 150. Thereafter, the back-end API 135 causes the presented check to be cleared (when the deposit is a check) at step 330, and, after the check is cleared, communicates with the financial institution API 115 to cause the first amount to be deposited in the user's account at the financial institution 110 at step 340, and communicates with the cryptocurrency exchange API 125 to cause the second amount to be converted from fiat money to cryptocurrency and deposited in the user's account at the cryptocurrency exchange 120 at step 350.

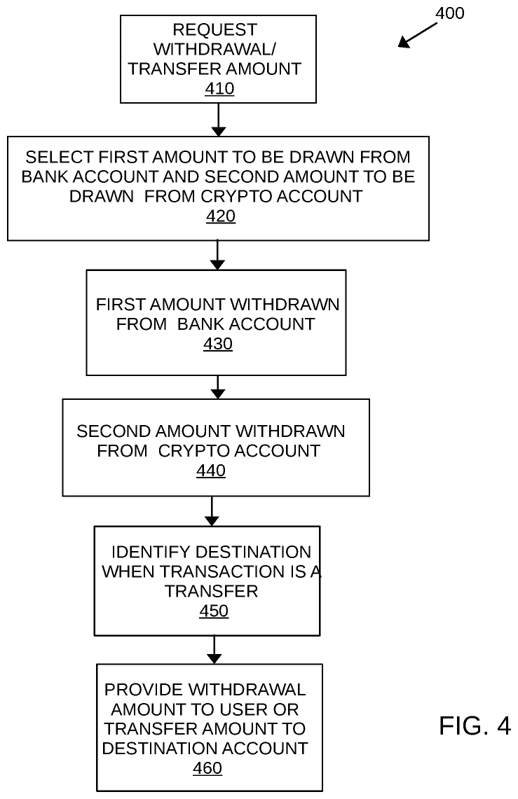

Referring now to FIG. 4, a flowchart 400 is shown that describes the process for a cash withdrawal or a transfer of funds from one or more of a user's accounts according to aspects of the present disclosure. First, a user makes a request for a withdrawal or transfer at step 410. This may be done at ATM 140 after presenting the user's banking card (or, in the case of a transfer, via the mobile banking app 165 running on the mobile device 160 of the user). Next, at step 420, the ATM 140 then presents the user with an interface (e.g., a slider interface as discussed above having a pointer that moves linearly from 0/100 to 100/0) that allows the user to select the amounts of the withdrawal or transfer to come from the user's bank account (the first amount) and from the user's crypto account (the second amount). Then, the back-end API 135 causes the first amount to be withdrawn from the user's bank account at step 430, and the back-end API 135 causes the second amount to be withdrawn from the user's crypto account and converted to fiat money at step 440. Next, at step 450, if the transaction is a transfer, the user is prompted to identify the destination account to receive the funds. Finally, at step 460, the total amount of the withdrawal is provided to the user at the ATM or the total amount of the transfer is provided to the destination account. The steps performed in flowchart 400 may be provided at a bank 150 via a withdrawal slip presented to a teller in a similar manner.

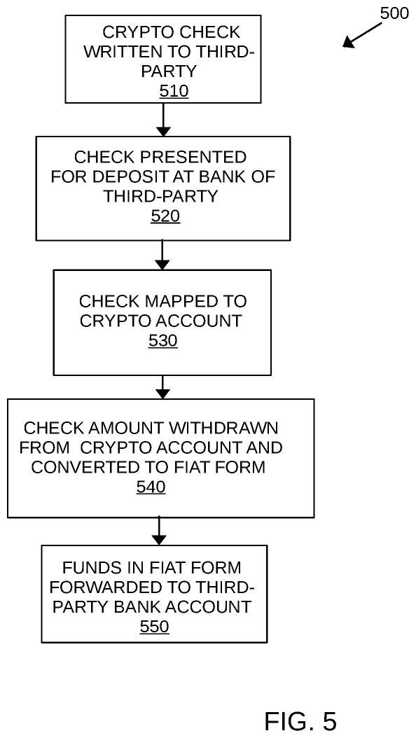

Referring now to FIG. 5, a flowchart 500 is shown that describes the process for issuing checks from a user's crypto account according to aspects of the present disclosure. A user having an account linking their bank account to their crypto account is provided with checks bearing an account number that is associated with the crypto account. A user writes a crypto check to a third-party at step 510 in an amount of fiat money. The third party presents the crypto check for deposit into their bank account at step 520. When the third-party's bank starts the clearance process, the back-end API 135 will map the check to the user's crypto account at step 530 by converting the amount of fiat money identified on the check to a corresponding amount of cryptocurrency, withdraw the necessary amount of cryptocurrency funds from the user's crypto account and then convert the cryptocurrency funds to a corresponding amount of fiat money form at step 540, and forward the funds in fiat money form to the third-party's bank account at step 550.

The back-end API 135 may preferably be provided with specifications that allow any third-party cryptocurrency exchange to directly interface on the crypto side and any financial institution customer to directly interface from the traditional banking side. The back-end API 135 provides automated and real-time conversion between fiat money and digital cryptocurrency. The back-end API 135 provides advantages to both financial institutions and to cryptocurrency exchanges by adding features and inter-compatibility not previously available to each. For example, financial institutions will gain exposure to the crypto market, retain customers who might otherwise depart for a crypto-based account, and gain customers interested in a dual banking/crypto solution. The back-end API 135 acts as a new third-party type intermediary that interacts between the financial institutions and cryptocurrency exchanges and provide the hardware/software needed to implement the system and method of the present disclosure.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method for interfacing between a financial institution and a cryptocurrency exchange, comprising:
receive a request for a banking transaction from a user via a back-end application programming interface running on an associated processor, the banking transaction including a first amount in fiat money related to an account of the user at the financial institution and a second amount in cryptocurrency funds related to an account of the user at the cryptocurrency exchange;
communicate, via the application programming interface running on the processor, with the financial institution to cause the banking transaction in the first amount to be performed by the financial institution on the account of the user at the financial institution;
convert, via the application programming interface running on the processor, the second amount in fiat money to an amount of cryptocurrency funds; and
communicate, via the application programming interface running on the processor, with the cryptocurrency exchange to cause the banking transaction in the amount of cryptocurrency funds to be performed by the cryptocurrency exchange on the account of the user at the cryptocurrency exchange.

2. The method of claim 1, wherein the banking transaction is a check deposit performed via a mobile banking application running on an associated processor on a mobile device of the user.

3. The method of claim 2, wherein the mobile banking application provides a slider interface allowing the user to select in one step the first amount in fiat money and the second amount in cryptocurrency funds, where the sum of the first amount and the second amount is equal to a total amount of the check deposit.

4. The method of claim 1, wherein the banking transaction is a deposit performed via a front-end interface running on an associated processor at an automated teller machine.

5. The method of claim 4, wherein automated teller machine provides, via the front-end interface running on the associated processor, a slider interface allowing the user to select in one step the first amount in fiat money and the second amount in cryptocurrency funds, where the sum of the first amount and the second amount is equal to a total amount of the deposit.

6. The method of claim 1, wherein the banking transaction is a deposit performed via an interaction with a teller interacting with a front-end interface running on an associated processor at a bank location associated with the financial institution.

7. The method of claim 1, wherein the banking transaction is a withdrawal performed via a front-end interface running on an associated processor at an automated teller machine.

8. The method of claim 7, wherein automated teller machine provides, via the front-end interface running on the associated processor, a slider interface allowing the user to select in one step the first amount in fiat money and the second amount in cryptocurrency funds, where the sum of the first amount and the second amount is equal to a total amount of the withdrawal.

9. The method of claim 1, wherein the banking transaction is a transfer to a destination account performed via a front-end interface running on an associated processor at one of a mobile device, an automated teller machine, or a bank location associated with the financial institution.

10. A method for interfacing with a cryptocurrency exchange, comprising:
receive a request for a banking transaction from a financial institution of a third party at a back-end application programming interface running on a processor, the banking transaction comprising a request to clear a check of a user to the third party in an amount of fiat money, the check of the user drawn on an account of the user at the cryptocurrency exchange;
convert, at the back-end application programming interface running on the processor, the amount in fiat money to an amount of cryptocurrency;
communicate, at the back-end application programming interface running on the processor, with the cryptocurrency exchange to cause the amount of cryptocurrency to be deducted from the account of the user at the cryptocurrency exchange;
receive, at the back-end application programming interface running on the processor, the deducted amount of cryptocurrency; and
convert, at the back-end application programming interface running on the processor, the received amount of cryptocurrency to a corresponding amount of fiat money.

11. The method of claim 10, further comprising transferring, by the back-end application programming interface running on the processor, the corresponding amount of fiat money to an account of the third party at the financial institution of the third party.

12. A system for interfacing between a financial institution and a cryptocurrency exchange, comprising:
a server having a processor and a non-transitory computer-readable storage medium, the server coupled to a financial institution and to a cryptocurrency exchange, the non-transitory computer-readable storage medium having executable instructions for a back-end application programming interface, which when executed, cause the processor to perform the following operations:
receive a request for a banking transaction from a user, the banking transaction including a first amount in fiat money related to an account of the user at the financial institution and a second amount in cryptocurrency funds related to an account of the user at the cryptocurrency exchange;
communicate with the financial institution to cause the banking transaction in the first amount to be performed by the financial institution on the account of the user at the financial institution;
convert the second amount in fiat money to an amount of cryptocurrency funds; and
communicate with the cryptocurrency exchange to cause the banking transaction in the amount of cryptocurrency funds to be performed by the cryptocurrency exchange on the account of the user at the cryptocurrency exchange.

13. The system of claim 12, wherein the banking transaction is a check deposit performed via a mobile banking application running on an associated processor on a mobile device of the user.

14. The system of claim 13, wherein the mobile banking application provides a slider interface allowing the user to select in one step the first amount in fiat money and the second amount in cryptocurrency funds, where the sum of the first amount and the second amount is equal to a total amount of the check deposit.

15. The system of claim 12, wherein the banking transaction is a deposit performed via a front-end interface running on an associated processor at an automated teller machine.

16. The system of claim 15, wherein automated teller machine provides, via the front-end interface running on the associated processor, a slider interface allowing the user to select in one step the first amount in fiat money and the second amount in cryptocurrency funds, where the sum of the first amount and the second amount is equal to a total amount of the deposit.

17. The system of claim 12, wherein the banking transaction is a deposit performed via an interaction with a teller interacting with a front-end interface running on an associated processor at a bank location associated with the financial institution.

18. The system of claim 12, wherein the banking transaction is a withdrawal performed via a front-end interface running on an associated processor at an automated teller machine.

19. The system of claim 18, wherein automated teller machine provides, via the front-end interface running on the associated processor, a slider interface allowing the user to select in one step the first amount in fiat money and the second amount in cryptocurrency funds, where the sum of the first amount and the second amount is equal to a total amount of the withdrawal.

20. The system of claim 12, wherein the banking transaction is a transfer to a destination account performed via a front-end interface running on an associated processor at one of a mobile device, an automated teller machine, or a bank location associated with the financial institution.
